(19) United States
(12) Patent Application Publication
(10) Pub. No.: US 2026/0149278 A1
(43) Pub. Date: May 28, 2026

(54) METHODS FOR A SYSTEM OF ACTIVE AND PASSIVE WATER GENERATION DEVICES FOR FREQUENCY LOAD BALANCING RECOGNIZED THROUGH A SENSOR NETWORK AND TRADING DESK

(71) Applicant: Ethonus, Inc., Tacoma, WA (US)

(72) Inventors: Karen Fleckner, Tacoma, WA (US); Jonathan Wood, Jerome, MI (US); Alexander Ferguson, Bethesda, MD (US); Michael Alexander, Great Falls, VA (US)

(73) Assignee: Ethonus, Inc., Tacoma, WA (US)

(21) Appl. No.: 19/402,364

(22) Filed: Nov. 26, 2025

Related U.S. Application Data
(60) Provisional application No. 63/725,859, filed on Nov. 27, 2024.

(51) Int. Cl. H02J 3/008; E03B 3/28; G06Q 40/04; G06Q 50/06; H02J 3/14; H02J 3/38; H02J 101/10; H02J 101/24; H02J 101/28; H02J 101/30; H04L 9/00

(52) U.S. Cl. CPC H02J 3/008; G06Q 40/04; G06Q 50/06; H02J 3/14; H02J 3/381; H04L 9/50; E03B 3/28; G06Q 2220/00; H02J 2101/10; H02J 2101/24; H02J 2101/28; H02J 2101/30

(57) ABSTRACT

A system includes devices configured to use electrical power to harvest atmospheric water including a sensor configured to measure water generated. The system also includes an electrical power source and a source of real time data regarding a price for power. The system also includes a switch operable to direct power from the power source to either (i) a power grid, or (ii) a water generation device. Processors of the system maintain a smart contract configured to mint power tokens in response to the price for power and the amount of power directed from the power source to the grid and a smart contract configured to mint water tokens in response to the amount of water generated. The processors also control the switch, causing either (i) the power production contract to mint power tokens or (ii) the water token contract to mint water tokens.

### CROSS-REFERENCE TO RELATED APPLICATIONS

This patent application is related to and claims priority to U.S. Provisional Patent Application No. 63/725,859, filed on Nov. 27, 2024, which is hereby incorporated by reference in its entirety.

### BACKGROUND

Atmospheric water generation (AWG) is the process of producing potable water from the humidity in the surrounding air. This is achieved through methods like condensing air with cooling coils, similar to a dehumidifier, or using special materials like hydrogels that absorb and release water. Unless the air is super-saturated with moisture, significant energy may be required to harvest water from the atmosphere. The energy required is a function of the humidity and temperature. That is, AWGs require specific environmental conditions to operate efficiently, such as a minimum air temperature and humidity level, and are less effective in colder or less humid climates. The energy cost can be a disincentive to producing clean water through AWG.

The disclosure of the present application addresses this and other issues.

### SUMMARY

The present disclosure relates generally to Atmospheric Water Generation (AWG) devices, both active and passive, and their use in a network of sensors and other sources of data for balancing production of water and generation of power. In an embodiment, a system for balancing electrical loads includes one or more active water generation devices, each active water generation device configured to use electrical power to harvest atmospheric water, each active water generation device comprising at least one sensor configured to measure an amount of water generated. The system further includes an electrical power source configured to produce electrical power at a substantially constant level. The system further includes a source of real time data regarding a price for electric power. The system further includes a switch operable to direct power from the electrical power source to either (i) a power grid, or (ii) at least one active water generation device of the one or more active water generation devices. The system further includes one or more processors and a computer-readable memory containing programming instructions. The programming instructions are configured to, when executed, cause the one or more processors to receive, from the source of real time data, the price (e.g., current or predicted) for electric power. The programming instructions are further configured to, when executed, cause the one or more processors to receive, from at least one water generation device, sensor data indicating the amount of water generated. The programming instructions are further configured to, when executed, cause the one or more processors to maintain multiple smart contracts on a digital ledger. The smart contracts include (i) a power production contract configured to mint power tokens in response to the amount of electrical power directed from the electrical power source to the power grid and the price for electric power and (ii) a water token contract configured to mint water tokens in response to the amount of water generated by the at least one water generation device, the water token contract further configured to transfer power tokens based on electrical power used by the at least one water generation device. The programming instructions are further configured to, when executed, cause the one or more processors to control the switch based on the price for electric power, causing either (i) the power production contract to mint power tokens in response to the amount of electrical power directed from the electrical power source to the power grid or (ii) the water token contract to mint water tokens in response to the amount of water generated by the at least one water generation device.

Implementations of the disclosure may include one or more of the following optional features. In some examples, the programming instructions that are configured to cause the one or more processors to control the switch include programming instructions that are configured to cause the one or more processors to control the switch based on a price (e.g., current or predicted) for water. The programming instructions may be further configured to cause the one or more processors to: store historical data in at least one data storage unit regarding the amount of electrical power directed from the electrical power source to the power grid and the amount of water generated by the at least one water generation device and determine the price for water based on the historical data. In some examples, the system further includes a digital trading desk configured to: transfer water tokens, based on the price for water, to one or more digital wallets and transfer power tokens, based on the price for electric power, to one or more digital wallets. The digital trading desk may be further configured to transfer water tokens and power tokens to one or more liquidity pools in exchange for pool tokens representing a value of the transferred water tokens and power tokens. The smart contracts may further include a smart pool contract configured to facilitate transferring the water tokens and power tokens to at least one of the one or more liquidity pools. In some examples, the system further includes a digital trading desk configured to transfer water tokens and/or power tokens to one or more digital wallets. A digital trading desk may be configured to transfer water tokens and power tokens to one or more liquidity pools in exchange for pool tokens representing a value of the transferred water tokens and power tokens. In an embodiment, at least one of the one or more active water generation devices is configured to provide generated water to a computer data center for cooling purposes. The electrical power source may be a nuclear power source configured to provide at least a continuous base load level of electric power.

In an embodiment, a method of balancing electrical loads includes receiving, from a source of real time data regarding a price for electric power, the price (e.g., current or predicted) for electric power. The method further includes receiving, from at least one active water generation device configured to use electrical power to harvest atmospheric water, sensor data indicating an amount of water generated by the at least one active water generation device. The method further includes maintaining multiple smart contracts on a digital ledger The smart contracts include (i) a power production contract configured to mint power tokens in response to the price for electric power and the amount of electrical power directed from an electrical power source configured to produce electrical power at a substantially constant level to a power grid and (ii) a water token contract configured to mint water tokens in response to the amount of water generated by the at least one active water generation device, the water token contract further configured to transfer power tokens based on electrical power used by the at least one active water generation device. The method further includes controlling a switch operable to direct power from the electrical power source, based on the price for electric power, causing either (i) the power production contract to mint power tokens in response to the amount of electrical power directed from the electrical power source to the power grid or (ii) the water token contract to mint water tokens in response to the amount of water generated by the at least one active water generation device.

Implementations of the disclosure may include one or more of the following optional features. In some examples, the controlling step includes controlling the switch based on a price (e.g., current or predicted) for water. The method may further include storing historical data in at least one data storage unit regarding the amount of electrical power directed from the electrical power source to the power grid and the amount of water generated by the at least one active water generation device and determining the price of water based on the historical data. The method may further include transferring, by a digital trading desk, at least one water token, based on the price of water, to one or more digital wallets. The method may further include transferring, by a digital trading desk, at least one water token and/or at least one power token to one or more liquidity pools in exchange for pool tokens representing a value of the transferred water tokens and/or power tokens. The smart contracts may include a smart pool contract configured to facilitate transferring the water tokens and power tokens to at least one of the one or more liquidity pools. In some examples, the method further includes transferring, by a digital trading desk, at least one water token, based on the price for water, and/or at least one power token, based on the price for electrical power, to one or more digital wallets. The method may further include providing generated water, by the at least one active water generation device, to a computer data center for cooling purposes. In some examples, controlling the switch to direct power from the electrical power source includes controlling the switch to direct at least a continuous base load level of electric power from a nuclear power source.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 shows an example AWG platform according to an embodiment.

FIG. 2 shows an example fog net according to an embodiment.

FIG. 3 shows an example embodiment including a microgrid.

FIG. 4 shows an example load/generation balancing embodiment.

FIG. 5 shows an example trading-desk embodiment.

FIG. 6 shows an example embodiment including a zero-trust network.

FIG. 7 shows a flowchart 700 of a method of generating water.

FIG. 8 shows a block diagram of an example of internal hardware that may be used to contain or implement program instructions according to an embodiment.

In the drawings, like reference numbers generally indicate identical or similar elements. Additionally, generally, the left-most digit(s) of a reference number identifies the drawing in which the reference number first appears.

### DETAILED DESCRIPTION

As used in this document, the singular forms “a,” “an,” and “the” include plural references unless the context clearly dictates otherwise. Unless defined otherwise, all technical and scientific terms used herein have the same meaning(s) as commonly understood by one of ordinary skill in the art. As used in this document, the term “comprising” (or “comprises”) means “including (or includes) but not limited to.” When used in this document, the term “exemplary” is intended to mean “by way of example” and is not intended to indicate that a particular exemplary item is preferred or required.

In this document, when terms such as “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/−10 percent of the value.

The present disclosure relates generally to Atmospheric Water Generation (AWG) devices, both active and passive, and their use in a network of sensors and other sources of data for balancing production of water and generation of power. The disclosure also relates to a trading desk, that may be implemented as one or more applications (apps). The apps may be associated with various digital tokens that may be transferred between digital wallets. Transactions may be executed according to smart contracts and recorded on digital ledgers.

A method for extracting water from the air within the troposphere utilizing large-scale arrays of AWGs configured in a nodal network and primarily powered by nuclear, both man-made—fission and fusion, as well as nuclear energy from the sun that can be concentrated through reflectors in the exosphere back to terrestrial solar power. The harvested water could then be stored and/or combined within terrestrial bodies of water—water ways, rivers, lakes, reservoirs, furthered by nuclear power and natural gravitational water flow to distribute areas of excess water to areas of water deficiency and gated through various methods of turbines for hydroelectric power generation, thus producing overall net water and power generation. Integrated with the AWG nodal networks would be monitoring and controls by sensor array(s) receiving data integrating multisource additional data from internal, external, analytics through Al/ML models on those data sources, aggregated pattern recognizer on atmosphere, water, and power, at the time of generation. Predictive analysis for trade-offs for optimum use of power, water, data based prioritized criteria. At the point of generation of water and power, data is generated and recognized through a digital ledger and smart contracts for digital trading desk based on commodities of water, and associated data that can supply a highly secure, zero-trust, and validated source of distributed or centralized digital currency.

In an embodiment, water is extracted from the air within the troposphere (ranging from ground level up to 20,000 meters) using active and/or passive methods. The active component includes large-scale arrays of AWGs with passive components of fog nets and rainwater capture. The water extraction and capture are a part of a platform that generates, stores, trades, and conveys water, power, and data. The water components are configured in a large-scale (10,000 gallon or more per day from the active component—AWG, and from 0.5 l/sq m up to 66/sq m per day) (mining atm rivers) nodal network and primarily powered by nuclear, both man-made—fission and fusion, as well as nuclear energy from the sun that can be concentrated through reflectors in the exosphere back to terrestrial solar power utilized in a power load balancing mechanism. One aspect of the invention of the water, energy, data platform is the utilization balancing power load (measured in frequency ranging from 60 hz to 50 hz to US and abroad standards) to produce water as a commodity when the power is in excess and demand low. Balancing power supply and demand through frequency regulation is required to keep the electrical system stable and produces high-quality power for on-demand use while creating a valuable water resource during excess power supply. This invention can be applied to a single power source meeting small intermittent demand cycles and can be scaled to microgrid configurations up to regional power grid balancing. Using the excess power to store energy in the form of water that can be generated through AWGs, or through hydrogen storage (that can be converted back into power at a later time). This process in contrast to pumped storage hydropower. Where pumped storage hydropower does not generate water rather uses excess power during off-peak hours to transport water to be stored from an upper reservoir (potential energy) to be re-used (kinetic energy) when the demand for electricity is high. Later in this cycle, excess power from that process is stored and used to pump water back to an upper reservoir and nowhere in the process is water created. This invention prefers nuclear power in various forms and can be a renewable source (in the case of solar power) and sustainable source of power (in the case of nuclear fission and fusion) and can be co-located with the platform or connect through the grid. Nuclear (fission/fusion) can be a reliable base load, however, off-peak power dips in demand can exacerbate the excess power availability. This embodiment can leverage excess power availability to create water from atmosphere during these times on a consistent basis and can be pre-scheduled and managed for optimum conditions by the sensor network aspect of the platform.

In the load-balancing case, the excess power will be used for a high-value commodity—water to be generated and stored through a system of active water generation—AWG and coupled with passive water generation including fog nets treated with photothermal material, and applying a drying mechanism of photo-molecular effect, and rainwater collection. The AWG unit(s), fog nets, and collected rainwater are coupled with a water storage tank with water treatment systems that filters, treats to reduce contaminants, and maintains water purity and/or clarity. Further fluid treatment processes that may be employed include advanced oxidation processes (AOP; e.g., ultra-violet radiation, ozone treatment, hydrogen peroxide treatment, etc.); filtration (e.g., micro-, nano-, and ultra-filtration); reverse osmosis; forward osmosis; applied pressure; applied vacuum; mechanical agitation; gas sparging and degassing; thermal treatments, (e.g., multi-stage flash distillation); membrane distillation; electrodialysis; biological reactors; anaerobic and aerobic biological treatment; chemical treatment systems; treatment with nucleation agents; treatment with absorbents; treatment with adsorbents; treatment with a biocide; flocculation; electro-flocculation systems; electro-coagulation systems; electromagnetic radiation; ion exchange columns or systems; treatment with a reducing agent, such as zero-valent iron; treatment with a catalyst; treatment with a photocatalyst; or a combination thereof. In some embodiments, an additional fluid treatment process includes applying electromagnetic radiation; catalysts; photocatalysts; chemicals; biocides; nucleating agents; adsorbents; absorbents; thermal energy; biochemistry; or a combination thereof.

In some embodiments, an additional fluid treatment process may be mineralization, chlorination, addition of United. States Food and Drug Administration (US-FDA) approved flavor and taste additives, filtration (including micro-, ultra-, and nano-filtration), softening, de-chlorination, de-ammonification, organic scavenging, de-ionization, reverse osmosis, forward osmosis, distillation, ultra-violet radiation, sterilization, or a combination thereof.

In embodiments, the fluid to be treated is drinking water. In such embodiments, the water produced may meet purity standards from federal, state, and local laws for one or more of potable water, drinking water, bottled water, mineral water, high-performance water (pH>7.0), purified water (as defined by the US Pharmacopeia (USP), water for injection (USP), water for special pharmaceutical purposes (LISP), water for hemodialysis (LISP), sterile purified water (USP), non-potable water, secondary-treated water, tertiary-treated water, and recycled/reclaimed water. In some embodiments, the water produced may meet purity standards from federal, state, and local laws for one or more of groundwater reinjection, surface water injection, indirect potable reuse, direct potable reuse, aquifer recharge, and aquifer storage and recovery.

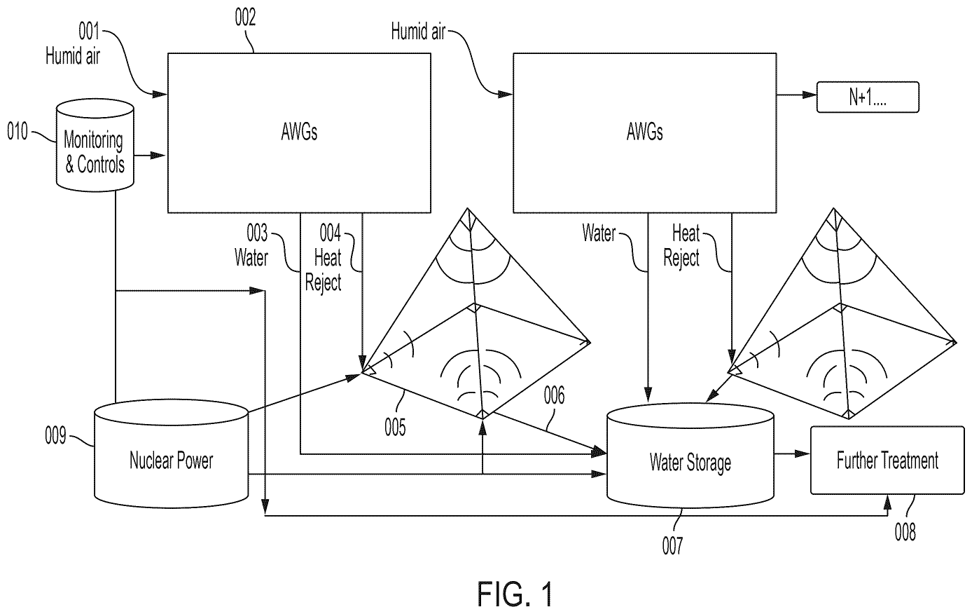

Referring to the embodiment of FIG. 1, a platform of the disclosure operates as a nodal network including active water generation with one or more AWGs combined with a passive water generation device. For example, the passive generation device could be a fog net, fog harp, rainwater collection, or combination thereof, within a nodal network of other water, power, and data monitoring and controls tied a trading desk. In FIG. 1, AWG 002 takes in humid air 001 generates water 003 and heat 004. The heat can be used to drive other process as a type of cogeneration. Include in the water generation “network” is a fog net 005. The fog net water output 006 in diverted to the water storage 007 where further water treatment can occur 008. Nuclear power 009 is generated and used to drive water generation process, monitoring and controls 010 that is integrated to a sensor network within the platform. This configuration can be repeat at large-scale.

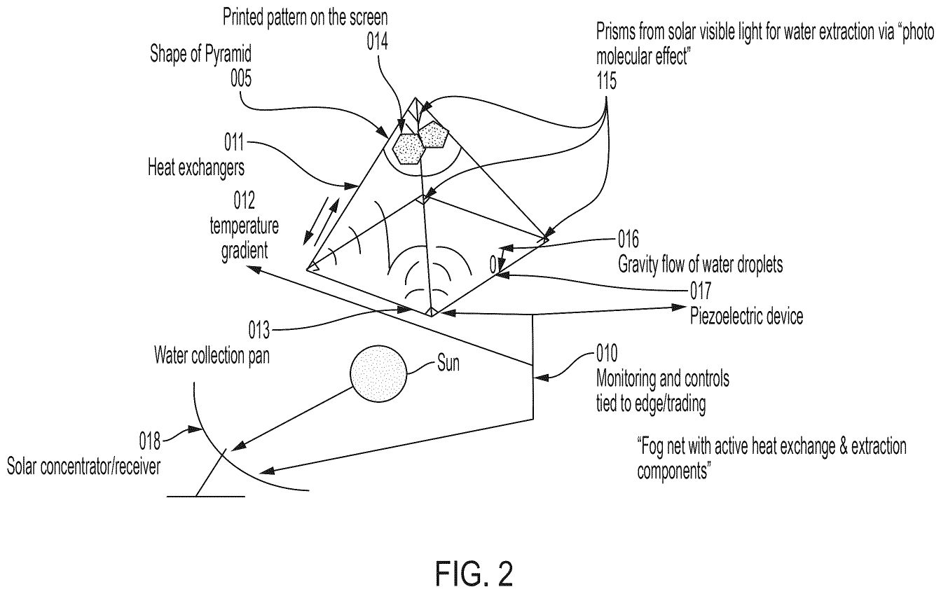

In embodiments, where the fog net 005 is in the shape of a pyramid to provide both increased surface area and structural integrity as it can be made of a metal mesh providing good heat transfer. The fog net can be further enhanced in FIG. 2 using a combination of absorption and water removal materials. Additionally, patterns such as polygons like honeycombed 014 configurations could further add to surface areas and structural integrity. Furthermore, to remove the water from the absorbed material such as hydrogels on the surface of the fog nets, photo electric effect material layered on the opposite side of the hydrogels would use prisms 115 from the visible light range (˜500 nm) refracting solar light provided from reflected concentrated solar from the exosphere. The solar source would be provided by mirrors collectors in space reflecting down to solar concentrators/receivers 018. The water that is removed from the absorbed material on the fog net via the photo molecular effect material will run/drop from the fog net into the water collection pan 013. When the drop of water driven by gravity 016 hit the pan piezoelectric device 017 located in connected to the pan would scavenge energy provided by the kinetic energy of the water drop hitting the pan. An additional driver to increase water condensation on the fog net would be provide by a heat exchanging mechanism 011 located at the seams of the pyramidal fog net. A temperature gradient 012 would be increased to move heat away from the surfaces of the fog net drawing via the seams where the exchangers are located. This mechanism could be driven by solar, nuclear, grid power, as well as a passive heat sync within the ground. All of the aforementioned device and mechanisms are monitored and controlled 010 and in response to the sensor network and trading desk aspects of the platform.

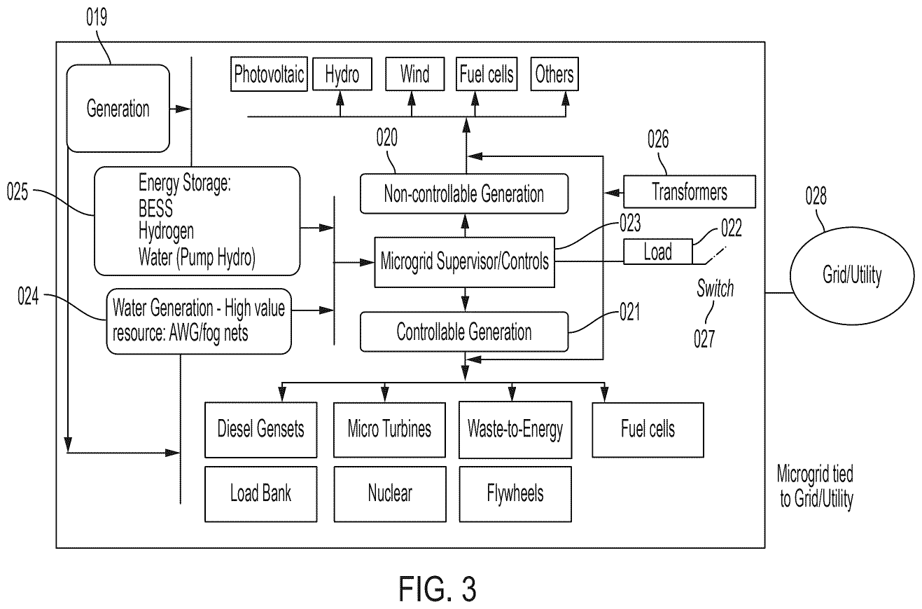

FIG. 3 shows an embodiment of the platform within a grid-tied 028 microgrid. The microgrid includes generation 019, load 022, water generation 024, and energy storage 025. The microgrid supervisor/controls 023 executes the decisions to balance the optimum trade space analysis as to when to produce water via AWGs/fog nets 024 when there is excess energy or storage in the form of battery energy storage system. Hydrogen, or pumped hydro. The power generation is categorized between controllable and non-controllable power sources. The controllable power generation devices 021 are the following: diesel gensets, micro turbines waste-to-energy, fuel cells, load banks, nuclear, flywheels to list a few. The non-controllable power generation devices 020 are the following: photovoltaic, hydro, wind, fuel cells, and others. The Additionally equipment of transformers 026 are shown to help balance the appropriate stepping up and down of voltage, with appropriate alternating and direct current (AC/DC) conversions to maintain power quality through the system. The microgrid and be in island mode, disconnected to the grid via switch gear 027 or it can be connected the grid.

The North American Power Transmission Grid is the electrical power grid that powers Northern America is not a single grid but is instead divided into multiple wide area synchronous grids. The Eastern Interconnection and the Western Interconnection are the largest. Three other regions include the Texas Interconnection, the Quebec Interconnection, and the Alaska Interconnection, which provide example use-cases for when to generate high-value water (commodity) to be traded.

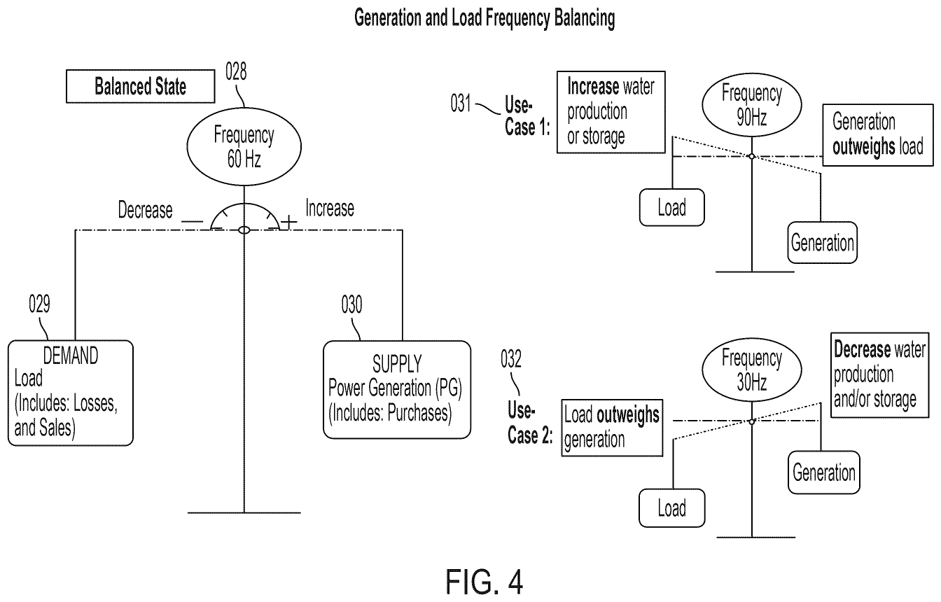

FIG. 4 shows an embodiment of how generation and load frequency are balanced at the North American Power Transmission Grid. In its balanced state 028, the frequency (by US standards) is 60 Hz where the demand 029 which includes loads, losses in the system and sales of power are offset by the supply 030 which includes power generation, and purchases. This invention is relevant to balancing authorities that are located where the generation needs to be increased as seen in Use-case 2 032. Renewable power, although desirable from an environmental perspective is intermittent and therefore “uncontrollable” and cannot be relied upon for base loading purposes. Nuclear can be a sustainable source of power that is controllable and, therefore, can be used for base loading on the grid. However, there are peak hours of power usage every day, usually around 6 AM-9 AM and the again at 5 PM-9 PM. This means that if nuclear were to be deployed at large scale, there would be an increased need to use that considerable and substantial constant power availability during off-peak hours. This invention would be highly desirable as it would not only utilize and help to balance power but also provide high-quality water that is in critical short supply.

Integrated in the platform with the AWG nodal networks and nuclear power would be monitoring and controls by sensor array(s) receiving data integrating multisource additional data from internal, external, analytics and AI/ML models on those data sources, aggregated pattern recognizer on atmosphere, water, and power, at the time of generation and based at least on data regarding geography, climate, weather, water, power, or a combination thereof. In embodiments that include more than one controller, the controllers for the senor network can communicate with one another using a direct communication connection (either wired or wireless) or via a common network. In such embodiments, each controller can operate and operate throughout the North American Power Transmission Grid. They orchestrate power frequencies intra and inter the various synchronous grids. When they have excess generation in one area of their region, they could either balance with load from other areas or use AWG to increase the load and generate high-quality water for sale via a digital trading desk. This example is shown in Use-case 1 031. Conversely, the AWG can be brough offline autonomously or can operate based on commands received from a central control station. In some embodiments, the central control station is in the same location as the controllers. In some embodiments, the central control station is located remotely. The common network may be any suitable network, such as an Ethernet network, a Modbus network, a CAN bus network, or some other appropriate communications network. A graphical user interface (GUI) can be used to control and/or monitor the system and include analytics, Artificial Intelligence (AI)/Machine Learning (AI/ML) that trains on internal, external, and other data from weather, government compliance metrics such as regulatory standards/information from FDA, EPA, emissions, national security, SCADA, carbon credit, and other such regulatory sources that may need to be used to verify, and validate the water, power, and data quality and quantity fit for use and consumption.

A controller for the sensor network may include a network communication device that can be connected to an external network. The external network can be a LAN, WAN, cloud, Internet, or some other network, and can be wired and/or wireless. Depending on the network, the protocol used can be any standard protocol, e.g., Ethernet, Modbus, CAN bus, TCP/IP, or any other appropriate protocol. Additionally, security and encryption technologies may be used. In some embodiments, the GUI may be in the form and function of a Common Operational Picture—a single identical display of relevant information shared by more than one Command. A COP facilitates collaborative planning and combined execution and assists all echelons to achieve situational awareness.

A controller or a central control station for the sensor network can include a database for storing information, including: readings from sensors, flow rate data, power consumption data, and the like. Such a database can be stored in computer-readable media, on a separate device, or both. Along with the database, computer-readable media can also include the operating system and/or application software.

In embodiments, the platforms of the disclosure are connected to one or more other devices via a network. In some embodiments, a control system of a platform of the disclosure is connected to one or more other devices via a network. In embodiments, the platform is connected to the Internet of Things (IoT). In some embodiments, a control system of a platform of the disclosure is connected to the IoT. In embodiments, data may be communicated using IoT protocols, such as Infrastructure (e.g., 6LowPAN, IPv4/IPv6, and RPL), Identification (e.g., EPC, uCode, IPv6, and URIs), Communications/Transport (e.g., Wifi, Bluetooth, and LPWAN), Discovery (e.g., Physical Web, niDNS, and DNS-SD), Data Protocols (e.g., MQTT, CORP, AMQP, Websocket, and Node), Device Management (e.g., TR-069 and OMA-DM), Semantic (e.g., JSON-LD and Web Thing Model), Multi-layer Frameworks, or a combination thereof.

An IoT-enabled control system may be in communication with an IoT system that tracks weather patterns at a larger scale (e.g., regional, state, national, etc.). In some embodiments, a control system, or a device connected to the control system via the network, uses data provided by the IoT system to model predicted weather conditions. In various embodiments, a control system may use data analysis tools, methods, and control strategies that include, for example, real-time model analysis; predictive modeling and control; artificial intelligence systems including, neural networks, fuzzy logic systems, genetic algorithms, and expert systems; software agents; knowledge management (KM) systems for data mining, cloud computing, parallel and distributed computing utilized in IoT for the fields of, e.g., Building Internet of Things (BIoT), smart cities, infrastructure and utilities, healthcare systems, insurance industry, and manufacturing; or a combination thereof.

In some embodiments, a platform of the disclosure operates as a node within a nodal network of other water, power, and data generators and distributors, which includes data sharing throughout the nodal network to achieve optimum intra-platform and inter-platform performance for the entire nodal network capable of fault tolerant operations, addressing redundancy, resiliency, and stability of system operations during nominal, optimal, and emergency use.

In embodiments, the fluid to be treated is water. In some embodiments, the fluid treatment systems may treat water for suitable purpose, such as, residential, industrial, indirect potable reuse, direct potable reuse (recycled water), ground water injection, commercial, food and beverage, hospitality, agricultural, mining, oil & gas, power, data centers, health-care, hospitals, nursing homes, pharmaceutical, government (e.g., military, federal, state, local, municipal, and foreign), security, space markets, emergency water use, fire-fighting use, or a combination thereof.

In further embodiments, a platform of the present disclosure may serve as a source for water and power in an emergency (e.g., for disaster response) or for locations in which it is preferable to not use conventional water or power. In such situations, platforms of the present disclosure may provide water resiliency (i.e., the ability to resist, absorb, accommodate to, and/or recover from the effects of a hazard in a timely and efficient manner) and water security. Such a platform may be configured as a satellite emergency response system for water treatment, power, and data communications to be deployed for emergency response and use. In various embodiments, a platform is configured to meet military-grade command, control, communication and computer (C4) operations for US Department of Defense (DoD) and Department of Homeland Security (DHS), as well as International Security Organizations (ISO). In such embodiments, the platform may be IoT enabled with necessary protocols to operate within DoD, DHS, and ISO specifications.

Predictive analysis for trade-offs for optimum use of power, water, data based prioritized criteria. Water, power, and data is generated and recognized through a digital trading desk including digital ledgers and smart contracts based on commodities of water, power, and associated data that can supply a highly secure, zero-trust, and validated source of distributed or centralized digital currency.

Another embodiment uses the platform and the AI/ML and analytics within the sensor network to make observations at locally and at scale for anomaly detection for predictive failures, outages, and for planning for building out of infrastructure and for emergencies and responses.

Another embodiment is that the harvested water from the AWGs, fog nets, and other passive water devices could then be stored and/or combined within terrestrial bodies of water—water ways, rivers, lakes, reservoirs, furthered by nuclear power and natural gravitational water flow to distribute areas of excess water to areas of water deficiency and gated through various methods of turbines for hydroelectric power generation, thus producing overall net water and power generation.

Another embodiment would be to capture water from atmospheric rivers that pass over orographic features like sides mountain ranges where the energy of the moisture laden weather pattern does not immediately precipitate but could be captured by combination of strategically placed AWG powered by the grid or renewables such as wind turbines in the correct form factor (cylindrical configurations) and large fog nets.

The trading desk components used in the written description and associated diagrams are defined below:
DApp: Decentralized Application. An application that can operate autonomously, through the use of smart contracts, that run on a decentralized computing (blockchain).
Smart Contract: Digital contracts stored on a blockchain that are automatically executed when predetermined terms and conditions are met.
Liquidity Pool: A collection of cryptocurrencies or digital assets that are locked in a smart contract to facilitate financial transactions.
Token: A cryptocurrency implemented as a smart contract on blockchain.
Zero-Trust Network: A security model that assumes no one or nothing should be trusted by default, regardless of their location or previous verification.
Wallet: A crypto wallet is a device, program, or online service that stores the keys to your cryptocurrency.

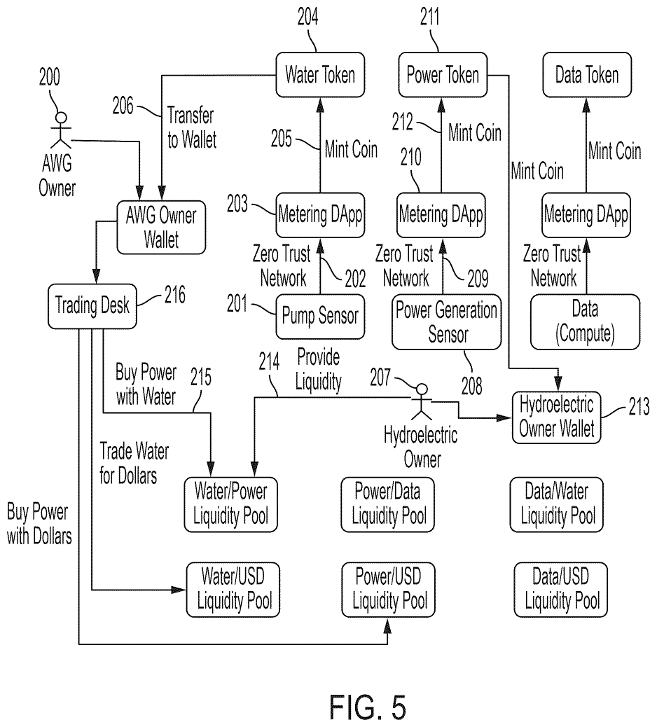

Referring to FIG. 5, the trading desk aspect of the platform has a preferred embodiment where the AWG Owner is producing water and is securely and digitally traded. This embodiment starts with the AWG Owner 200 producing water which is pumped into a tank. The pump has a sensor 201 attached that reports the number of gallons pumped. The sensor also has a zero-trust networking client 202 installed. The client software is pre-configured with identity and cryptographic material for communicating with the Metering DApp. The Metering DApp 203 has a cryptocurrency wallet embedded in it. For each gallon of water pumped, the Metering DApp will invoke a function on the Water Token smart contract 204, minting a Water Token 205 and transferring it to AWG Owner's crypto wallet 206.

Another embodiment shows the Hydroelectric Owner 207 operating a pumped storage hydropower facility that includes 2 reservoirs, one higher than the other. The reservoirs are connected and between the two is a power generation turbine. Hydroelectric Owner 207 pumps water into the higher reservoir using grid energy when it is inexpensive. The turbine is monitored by a sensor 208 that reports the energy produced. The sensor also has a zero-trust networking client 209 installed. The client software is pre-configured with identity and cryptographic material for communicating with the Metering DApp 210. For each kilowatt of electricity produced the Metering DApp will invoke a function on the Power Token smart contract 211, minting a Power Token 212 and transferring it to the Hydroelectric Owner's crypto wallet 213. In one example, Hydroelectric Owner 207 has 1 billion Water Tokens representing the water volume of the reservoirs and 1 billion Power Tokens from power-generation activities. Hydroelectric Owner 207 would like to use these tokens to generate revenue without liquidating them on a decentralized exchange. In this example, the Hydroelectric Owner 207 creates a liquidity pool via smart contract using 1 billion Water tokens and 1 billion Power tokens 214. They would receive a special purpose Liquidity Pool Token in exchange. The Hydroelectric Owner 207 will also receive a portion of the transaction fees for any usage of the pool. They also can stake his Liquidity Pool Tokens (LPs), locking them up for a while. In exchange for the staking action, the Hydro Electric Owner receives more revenue and may transfer the LP tokens to a different wallet or exchange his liquidity pool tokens for the underlying assets. These liquidity pools can be distributed or centralized through a Central Bank Digital Currency (CBDC).

Meanwhile, the AWG Owner has pumped 10 million gallons of water into their tank. Their wallet concurs and shows 10 million Water Tokens. The AWG owner would like to pump more water but cannot afford to pay for the electricity in dollars. They look for a liquidity pool and find Hydro Electric Owner's Power/Water pool. The AWG Owner exchanges 1 million Water tokens for 1 million Power tokens 215. The Power/Water pool now has more Water tokens than Power tokens, effectively lowering Water token value and raising Power token values slightly.

The Trading Desk (216) is a DApp that can be connected to a digital wallet. It provides views of the assets in the wallet and exchange rates for other currencies. You can send, receive and exchange crypto currencies within this Dapp.

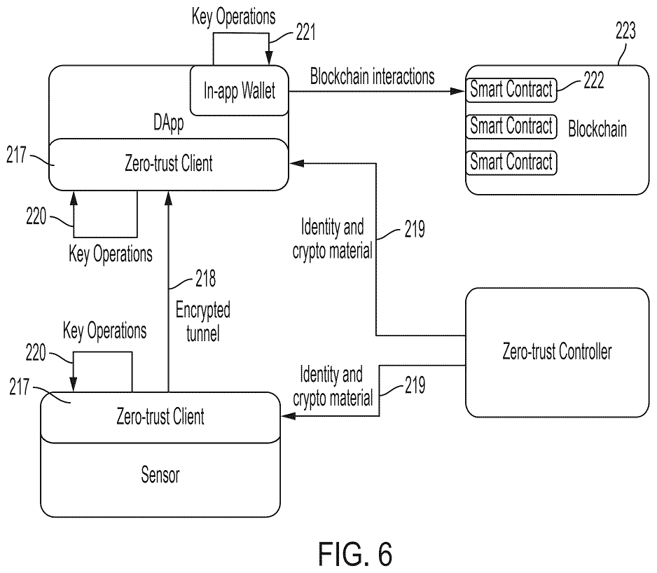

Referring to FIG. 6, To ensure tamper-free sensor readings, a zero-trust network is employed. This network includes two clients 217 who negotiate an encrypted tunnel 218. The identity of the clients is known and a part of the authentication model 219. Each device manages its own key generation and signs its key material using an automated mechanism 220. Unique key material is generated for each peer-to-peer connection. This key material is rotated for every session. The platform is both secure and transparent. Once the Metering DApp 203, 210 receives readings and determines that a minting or transfer action should take place, the request is formed and signed by the DApp's in-app wallet keys 221. The blockchain execution of the smart contract verifies the signature before executing the action 222. All transactions may be viewed on the blockchain 223.

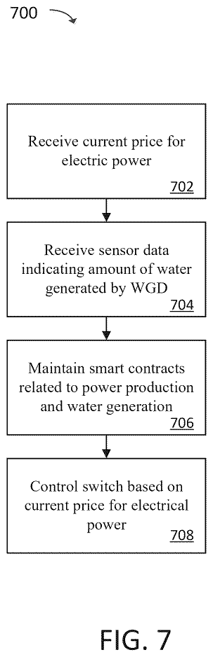

FIG. 7 shows a flowchart 700 of a method of balancing electrical loads. At step 702, the method includes receiving, from a source of real time data regarding a price for electric power, the price (e.g., current or predicted) for electric power. That is, the method may include predicting when the power will be in excess and/or power demand will be low. Knowing the price of power allows the system to advantageously use excess power to store energy in the form of water that can be generated through AWGs, or through hydrogen storage (that later can be converted back into power at a later time), or merely produce water for cooling or other non-power related function. At step 704, the method includes receiving, from at least one active water generation device configured to use electrical power to harvest atmospheric water, sensor data indicating an amount of water generated by the at least one active water generation device. That is, the AWG devices (active or passive) may be part of a nodal network including a network of sensors and other sources of data for balancing production of water and generation of power. Each AWG may include a sensor indicating an amount of water production by that AWG. At step 706, the method includes maintaining multiple smart contracts on a digital ledger. The smart contracts may include (i) a power production contract configured to mint power tokens in response to the price for electric power and the amount of electrical power directed from an electrical power source (e.g., a power source configured to produce electrical power at a substantially constant level) to a power grid and (ii) a water token contract configured to mint water tokens in response to the amount of water generated by the at least one active water generation device, the water token contract further configured to transfer power tokens based on electrical power used by the at least one active water generation device. These smart contracts enable the system to incorporate intelligence for optimizing economic results, e.g., highest margin and greatest resilience. At step 708, the method includes controlling a switch operable to direct power from the electrical power source, based on the price for electric power, causing either (i) the power production contract to mint power tokens in response to the amount of electrical power directed from the electrical power source to the power grid or (ii) the water token contract to mint water tokens in response to the amount of water generated by the at least one active water generation device. These tokens can be traded against various factors or standard requirements included in the smart contracts, allowing the system to include intelligence to guide trading tokens and/or contracts, e.g., when attractive conditions arise.

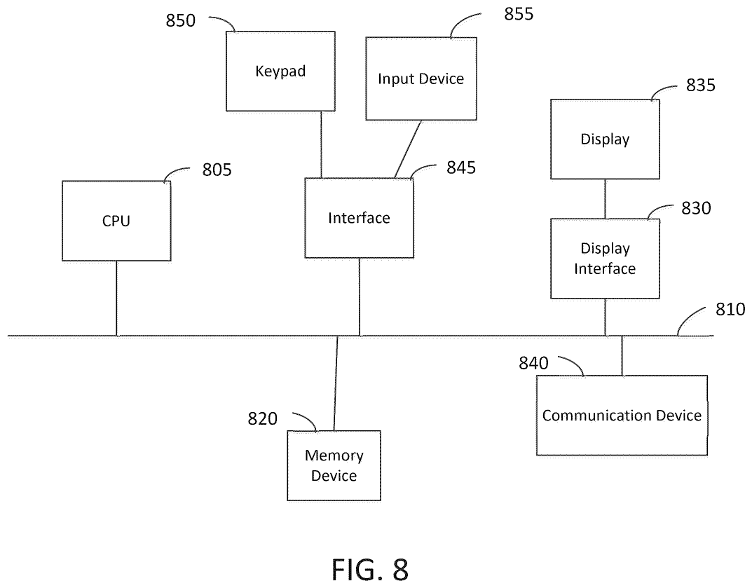

FIG. 8 illustrates example hardware that may be used to contain or implement program instructions. A bus 810 serves as the main information highway interconnecting the other illustrated components of the hardware. Processor 805 is a central processing device of the system, configured to perform calculations and logic operations required to execute programming instructions. As used in this document and in the claims, the terms “processor” and “processing device” may refer to a single processor 805 or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 820. Read only memory (ROM) and random-access memory (RAM) constitute examples of non-transitory computer-readable storage media 820, memory devices or data stores as such terms are used within this disclosure.

Program instructions, software or interactive modules for providing the interface and performing any querying or analysis associated with one or more data sets may be stored in the memory device 820. Optionally, the program instructions may be stored on a tangible, non-transitory computer-readable medium such as a compact disk, a digital disk, flash memory, a memory card, a universal serial bus (USB) drive, an optical disc storage medium and/or other recording medium.

An optional display interface 830 may permit information from the bus 810 to be displayed on the display 835 in audio, visual, graphic or alphanumeric format. Communication with external devices may occur using various communication ports 840. A communication port 840 may be attached to a communications network, such as the Internet or an intranet.

An optional display interface 830 may permit information from the bus 810 to be displayed on a display device 835 in visual, graphic or alphanumeric format. An audio interface and audio output (such as a speaker) also may be provided. Communication with external devices may occur using various communication devices 840 such as a wireless antenna, a radio frequency identification (RFID) tag and/or short-range or near-field communication transceiver, each of which may optionally communicatively connect with other components of the device via one or more communication system. The communication device(s) 840 may include a transmitter, transceiver, or other device that is configured to be communicatively connected to a communications network, such as the Internet, a Wi-Fi or local area network or a cellular telephone data network, or to make a direct communication connection with one or more nearby devices, such as a Bluetooth transmitter or infrared light emitter.

The hardware may also include a user interface sensor 845 that allows for receipt of data from a keyboard or keypad 850 or other input devices 855 such as, a joystick, a touchscreen, a touch pad, a remote control, a pointing device, camera, and/or microphone.

In this document, an “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data store,” “data storage facility” and the like each refer to a non-transitory device on which computer-readable data, programming instructions or both are stored. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Furthermore, when a particular feature, structure, or characteristic is described in connection with an embodiment, it would be within the knowledge of persons skilled in the relevant art(s) to incorporate such feature, structure, or characteristic into other embodiments, whether or not explicitly mentioned or described in this document. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but still co-operate or interact with each other.

While the invention has been described with specific embodiments, other alternatives, modifications and variations will be apparent to those skilled in the art. Accordingly, it will be intended to include all such alternatives, modifications, and variations within the spirit and scope of the appended claims.

1. A system for balancing electrical loads, the system comprising:
one or more active water generation devices, each active water generation device configured to use electrical power to harvest atmospheric water, each active water generation device comprising at least one sensor configured to measure an amount of water generated;
an electrical power source configured to produce electrical power at a substantially constant level;
a source of real time data regarding a price for electric power;
a switch operable to direct power from the electrical power source to either (i) a power grid, or (ii) at least one active water generation device of the one or more active water generation devices;
one or more processors; and
a computer-readable memory containing programming instructions that are configured to, when executed, cause the one or more processors to:
receive, from the source of real time data, the price for electric power;
receive, from at least one water generation device, sensor data indicating the amount of water generated;
maintain a plurality of smart contracts on a digital ledger, the plurality of smart contracts comprising:
a power production contract configured to mint power tokens in response to the amount of electrical power directed from the electrical power source to the power grid and the price for electric power; and
a water token contract configured to mint water tokens in response to the amount of water generated by the at least one water generation device, the water token contract further configured to transfer power tokens based on electrical power used by the at least one water generation device; and
control the switch based on the price for electric power, causing either (i) the power production contract to mint power tokens in response to the amount of electrical power directed from the electrical power source to the power grid or (ii) the water token contract to mint water tokens in response to the amount of water generated by the at least one water generation device.

2. The system of claim 1, wherein the programming instructions that are configured to cause the one or more processors to control the switch comprise programming instructions that are configured to cause the one or more processors to control the switch based on a price for water.

3. The system of claim 2, wherein the programming instructions are further configured to cause the one or more processors to:
store historical data in at least one data storage unit regarding the amount of electrical power directed from the electrical power source to the power grid and the amount of water generated by the at least one water generation device; and
determine the price for water based on the historical data.

4. The system of claim 3, further comprising:
a digital trading desk configured to:
transfer water tokens, based on the price for water, to one or more digital wallets; and
transfer power tokens, based on the price for electric power, to one or more digital wallets.

5. The system of claim 4, wherein the digital trading desk is further configured to transfer water tokens and power tokens to one or more liquidity pools in exchange for pool tokens representing a value of the transferred water tokens and power tokens.

6. The system of claim 5, wherein the plurality of smart contracts further comprise a smart pool contract configured to facilitate transferring the water tokens and power tokens to at least one of the one or more liquidity pools.

7. The system of claim 1, further comprising a digital trading desk configured to transfer water tokens and/or power tokens to one or more digital wallets.

8. The system of claim 1, further comprising a digital trading desk configured to transfer water tokens and power tokens to one or more liquidity pools in exchange for pool tokens representing a value of the transferred water tokens and power tokens.

9. The system of claim 1, wherein at least one of the one or more active water generation devices is configured to provide generated water to a computer data center for cooling purposes.

10. The system of claim 1, wherein the electrical power source is a nuclear power source configured to provide at least a continuous base load level of electric power.

11. A method of balancing electrical loads, the method comprising:
receiving, from a source of real time data regarding a price for electric power, the price for electric power;
receiving, from at least one active water generation device configured to use electrical power to harvest atmospheric water, sensor data indicating an amount of water generated by the at least one active water generation device;
maintaining a plurality of smart contracts on a digital ledger, the plurality of smart contracts comprising:
a power production contract configured to mint power tokens in response to the price for electric power and the amount of electrical power directed from an electrical power source configured to produce electrical power at a substantially constant level to a power grid; and
a water token contract configured to mint water tokens in response to the amount of water generated by the at least one active water generation device, the water token contract further configured to transfer power tokens based on electrical power used by the at least one active water generation device; and
controlling a switch operable to direct power from the electrical power source, based on the price for electric power, causing either (i) the power production contract to mint power tokens in response to the amount of electrical power directed from the electrical power source to the power grid or (ii) the water token contract to mint water tokens in response to the amount of water generated by the at least one active water generation device.

12. The method of claim 11, wherein the controlling step comprises controlling the switch based on a price for water.

13. The method of claim 12, further comprising:
storing historical data in at least one data storage unit regarding the amount of electrical power directed from the electrical power source to the power grid and the amount of water generated by the at least one active water generation device; and
determining the price of water based on the historical data.

14. The method of claim 13, further comprising:
transferring, by a digital trading desk, at least one water token, based on the price of water, to one or more digital wallets.

15. The method of claim 13, further comprising:
transferring, by a digital trading desk, at least one power token, based on the price of electrical power, to one or more digital wallets.

16. The method of claim 13, further comprising transferring, by a digital trading desk, at least one water token and/or at least one power token to one or more liquidity pools in exchange for pool tokens representing a value of the transferred water tokens and/or power tokens.

17. The method of claim 16, wherein the plurality of smart contracts further comprise a smart pool contract configured to facilitate transferring the water tokens and power tokens to at least one of the one or more liquidity pools.

18. The method of claim 12, further comprising:
transferring, by a digital trading desk, at least one water token, based on the price for water, and/or at least one power token, based on the price for electrical power, to one or more digital wallets.

19. The method of claim 11, further comprising:
providing generated water, by the at least one active water generation device, to a computer data center for cooling purposes.

20. The method of claim 11, wherein controlling the switch to direct power from the electrical power source comprises controlling the switch to direct at least a continuous base load level of electric power from a nuclear power source.
